(19) United States
(12) Patent Application Publication
(10) Pub. No.: US 2025/0362004 A1
(43) Pub. Date: Nov. 27, 2025

(54) LIGHTING HOUSING

(71) Applicant: Lumenture, Inc., Monroe, CT (US)

(72) Inventors: Jonas Concepcion, Monroe, CT (US); Kyle L. Rutkunas, Monroe, CT (US); James D. Leahy, Monroe, CT (US)

(21) Appl. No.: 19/217,380

(22) Filed: May 23, 2025

Related U.S. Application Data
(60) Provisional application No. 63/651,116, filed on May 23, 2024.

(51) Int. Cl. F21V 15/01; F21V 21/04

(52) U.S. Cl. CPC F21V 15/01; F21V 21/04

(57) ABSTRACT

A lighting housing can be structured and configured to include an internal wiring junction box. In some embodiments, components, such as a cover and pan (e.g., base), of the lighting housing are structured to be stackable when the lighting housing is unassembled. In some embodiments, the components of the lighting housing are configured to be assembled using snap fits (e.g., rather than rivets or other fasteners).

### CROSS-REFERENCE TO RELATED APPLICATION

The present patent application claims the benefit of priority to U.S. Provisional Application No. 63/651,116, filed May 23, 2024. The aforementioned patent application is incorporated by reference herein in its entirety for all purposes.

### TECHNICAL FIELD

The present disclosure relates to lighting devices, particularly lighting enclosures.

### BACKGROUND

Various types of lighting devices, such as light fixtures, are ubiquitous and have experienced widespread adoptions in a myriad of applications. But conventional lighting devices still have certain deficiencies. For example, wiring compartments of a lighting device that serve to enclose luminaire wiring and branch circuit terminations are often exposed or unsealed, presenting safety risks.

The present disclosure provides embodiments that address these and other deficiencies.

### SUMMARY

Embodiments described or otherwise contemplated herein substantially meet the aforementioned needs of the industry. Embodiments of the present disclosure provides various improvements to the state of the art in lighting systems.

In a feature and advantage of embodiments, components of an improved lighting housing are stackable when lighting housing is unassembled.

In a feature and advantage of embodiments, an improved lighting housing is assembled through tensioning (e.g., without loose fasteners).

In a feature and advantage of embodiments, an improved lighting housing internally incorporates a wiring junction box.

In some embodiments, a lighting housing, includes separable a cover and a pan. The cover includes a rim defining an aperture to an internal cavity. A portion of the rim can include a raised edge. The pan includes a perimeter wall configured to surround and continuously contact the rim of the cover such that the raised edge is parallel to the perimeter wall when the cover and the pan are engaged. An inner face of the perimeter wall includes an integrally formed tab configured to engage the raised edge by extending inwardly relative to the cover. The tab can be structured such that applying pressure to the tab causes the tab to resiliently deform and disengage from the raised edge.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the method and system of the disclosure. Together with the description, the drawings serve to explain the principles of the disclosed embodiments.

### BRIEF DESCRIPTION OF THE DRAWINGS

Subject matter hereof may be more completely understood in consideration of the following detailed description of various embodiments in connection with the accompanying figures, in which:

FIG. 1 illustrates a top front isometric view of a light housing, according to an embodiment of the disclosure.

FIG. 2 illustrates a top rear isometric view of the light housing of FIG. 1.

FIG. 3 illustrates a front view of the light housing of FIG. 1.

FIG. 4 illustrates a side view of the light housing of FIG. 1.

FIG. 5 illustrates a top plan view of the light housing of FIG. 1.

FIG. 6 illustrates a bottom plan view of the light housing of FIG. 1.

FIG. 7 illustrates an exploded view of a light housing and lighting element, according to an embodiment.

FIG. 8 illustrates a further top rear isometric view of the light housing in an assembled configuration, according to an embodiment.

FIG. 9 illustrates a bottom rear isometric view of the light housing of FIG. 8 in an assembled configuration.

FIG. 10 illustrates housing covers in a storage configuration, according to an embodiment.

FIG. 11 illustrates housing pans in a storage configuration, according to an embodiment.

FIG. 12A illustrates a lighting housing in a partially assembled state, according to an embodiment.

FIG. 12B illustrates an expanded view of region A of FIG. 12A.

FIG. 13A illustrates a lighting housing in an assembled configuration, according to an embodiment.

FIG. 13B illustrates an expanded view of region B of FIG. 13A.

FIG. 14 illustrates a top front isometric partially exploded view of a light housing, according to an embodiment.

FIG. 15 illustrates a bottom rear isometric partially exploded view of a light housing, according to an embodiment.

FIG. 16 illustrates a top side isometric partially exploded view of a light housing, according to a further embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure provides improvements to the current state of the art of lighting fixtures and enclosures. Embodiments of the present disclosure allow for a lighting housing that is structured and configured to contain a wiring junction box. In some embodiments, components, such as a cover and pan (e.g., base), of the lighting housing are structured to be compactly stored when the lighting housing is unassembled. In some embodiments, the components of the lighting housing are configured to be assembled using (e.g., exclusively using) snap fits (e.g., rather than rivets or other fasteners).

In accordance with one aspect, the present disclosure provides implementations of an improved lighting housing that has stackable components when unassembled.

In accordance with a second aspect, the present disclosure provides implementations of an improved lighting housing that can be assembled through tensioning (e.g., without loose fasteners).

In accordance with a third aspect, the present disclosure provides implementations of an improved lighting housing that can internally house a wiring junction box. In some conventional lighting housings, the wiring junction box is external, presenting safety and regulatory concerns. The improved lighting housing can incorporate the wiring junction box without the need to seal (e.g., tape, caulk, etc.) all seems to prevent air movement.

In some embodiments, the lighting housing can efficiently be manipulated between a storage (e.g., unassembled) configuration and an assembled configuration. In addition, seams between components of the lighting housing can prevent air movement to comply with regulatory requirements.

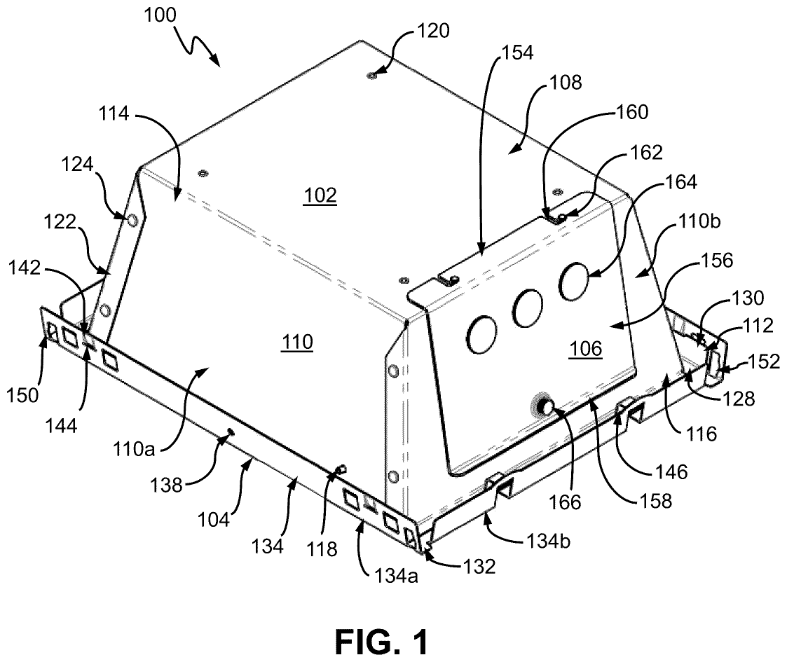

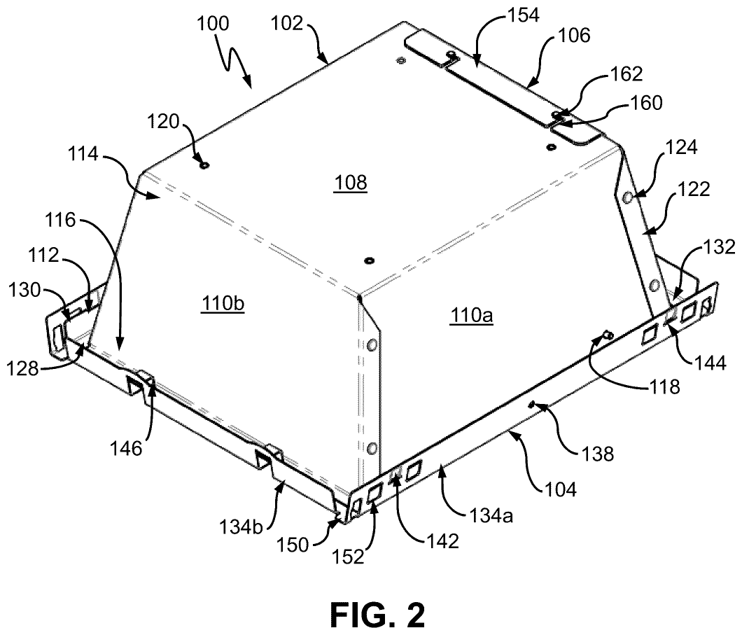

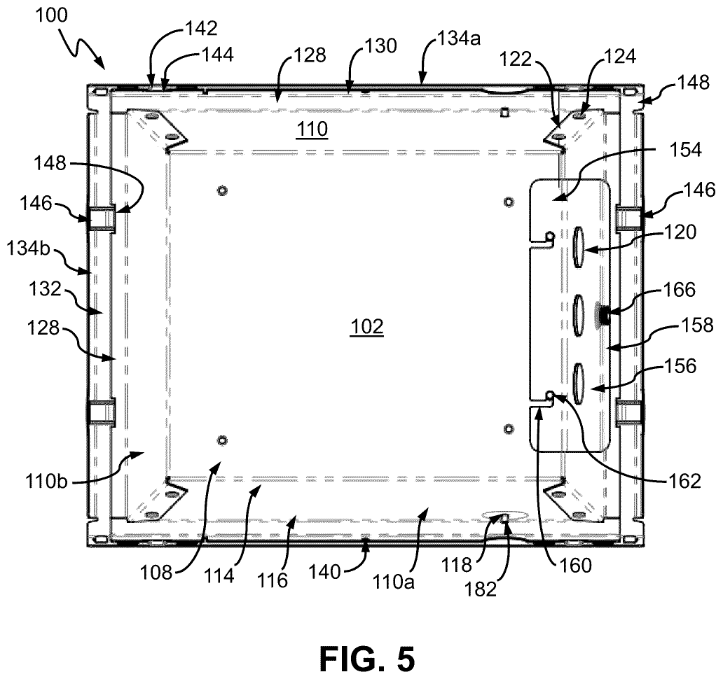

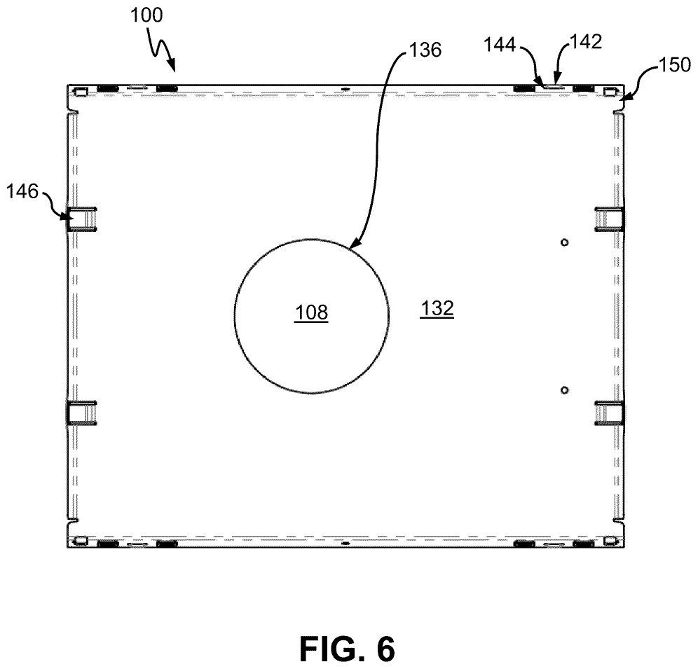

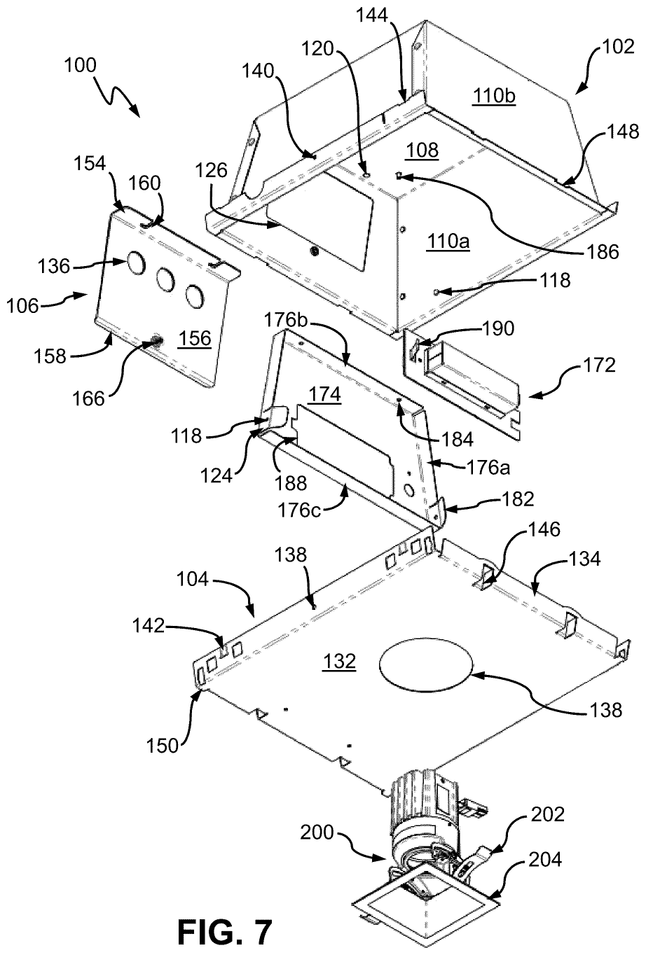

Referring to FIGS. 1-6, various views of a lighting housing 100 in an assembled configuration are depicted, according to an embodiment of the present disclosure. Lighting housing 100 includes a housing cover 102, a housing pan 104, and a wiring door 106.

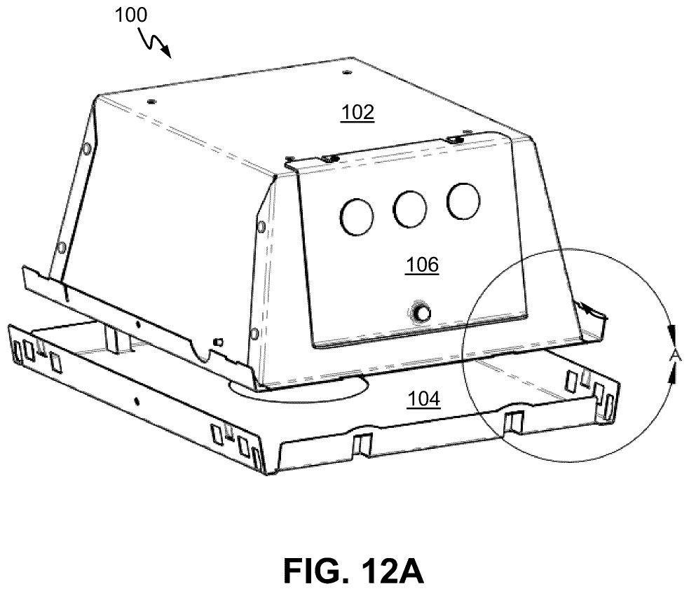

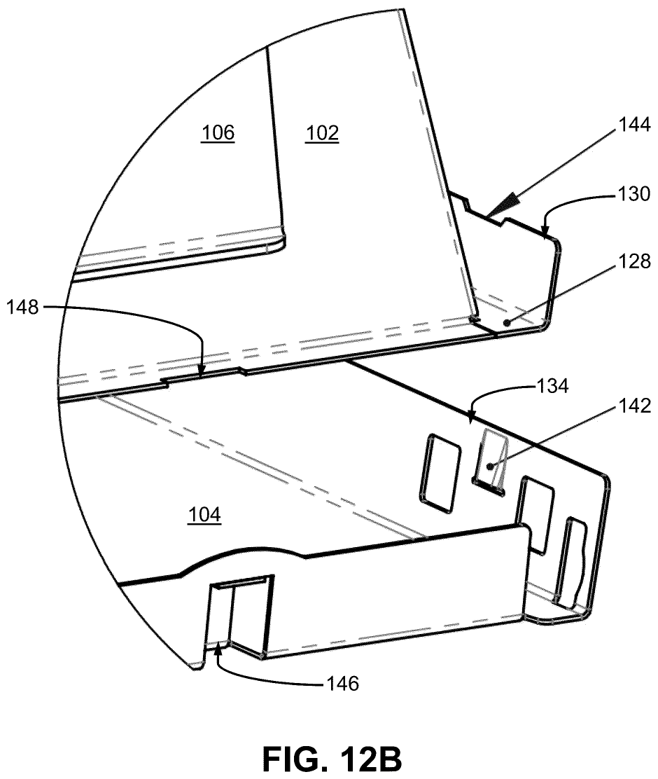

In embodiments, housing cover 102, housing pan 104, and wiring door 106 are selectively couplable, for example, such that housing cover 102, housing pan 104, and wiring door 106 are movable between an assembled configuration and a storage configuration. The assembled configuration, as illustrated in FIGS. 1-6, can comprise housing cover 102, housing pan 104, and wiring door 106 being selectively coupled, for example, as a single housing unit. The storage configuration (e.g., as illustrated in FIGS. 10 and 11) can comprise housing cover 102, housing pan 104, and wiring door being uncoupled, for example, as separate pieces.

Housing cover 102 generally includes a planar surface 108, sidewalls 110, and a rim 112. Planar surface 108 and sidewalls 110 collectively define a cavity sized and otherwise adapted to receive a lighting element (not shown in FIGS. 1-6). The cavity extends between planar surface 108 and an opening defined by an inner perimeter of rim 112.

In embodiments, the cavity defined by housing cover 102 is sized to accommodate a lighting element when in an assembled configuration with housing pan 104 and wiring door 106. In some implementations, the cavity can be configured to house, for example, one or more of: a light source (e.g., an incandescent bulb, fluorescent tube, LED module, or any other type of lighting technology), a reflectors (e.g., to control the direction of light), a diffuser (e.g., to diffuse light), a ballast or driver (e.g., to regulate electrical current), wiring and connectors, or a heat sink. For example, for high-power LED fixtures, a heat sink may be contained within housing cover 102 to dissipate excess heat generated by the light source, ensuring performance and longevity.

Sidewalls 110 include a top edge 114 integrated with planar surface 108 and a bottom edge 116 integrated with rim 112. As depicted in FIGS. 1-4, the widths of sidewalls 110 are tapered, extending from planar surface 108 to rim 112 (e.g., from top edge 114 to bottom edge 116). The tapered sidewalls 110 give lighting housing 100 a shape of a trapezoidal prism with a wide base defined by rim 112.

Sidewalls 110 include opposing first sidewalls 110a and opposing second sidewalls 110b. In some embodiments, the widths of first sidewalls 110a along top edge 114 and bottom edge 116 are greater than the respective widths of second sidewalls 110b. In some embodiments, the height of first sidewalls 110a (e.g., dimension between top edge 114 and bottom edge 116) is equal to the height of second sidewalls 110b.

First sidewalls 110a are straight-sided. Second sidewalls 110b can include protrusions 122 that extend from the sides of second sidewalls 110b between from top edge 114 and bottom edge 116. Protrusions 122 are bent (e.g., folded) along first sidewalls 110a such that protrusions 122 are parallel to first sidewalls 110a. Protrusions 122 are structured to strengthen housing cover 102 against buckling or failure. In the illustrated embodiment, protrusions 122 have rectilinear features. In some implementations, protrusions 122 can include different configurations or dimensions (e.g., capable of support the structural resilience of light housing 100).

In some embodiments, first sidewalls 110a and second sidewalls 110b are sealed or otherwise coupled along protrusions 122. For example, fasteners 124 are configured to join first sidewalls 110a and second sidewalls 110b. Fasteners 124 can be incorporated and positioned along protrusions 122 to further support and maintain the shape of housing cover 102. In embodiments, fasteners 124 can be integrated fastening mechanisms, such as snap fits, buttons, and the like. In embodiments, protrusions 122 can be permanently integrated with first sidewalls 110a such that a seal is formed. For example, sidewalls 110 can be welded along bent protrusions 122.

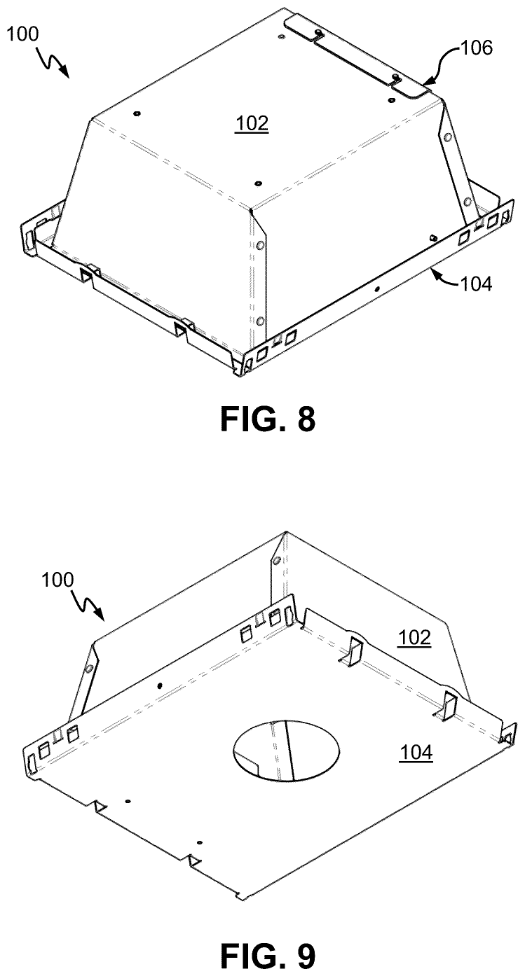

One side of second sidewalls 110b includes a wiring aperture 126 (e.g., as illustrated in FIG. 7). Wiring aperture 126 is configured to be covered by wiring door 106 when in an assembled configuration. Wiring aperture 126 is positioned at a height along sidewall 110 that is less than the height of wiring door 106.

Rim 112 surrounds the distal end of sidewalls 110 and protrudes generally outward from the bottom edge 116 of sidewalls 110. Rim 112 defines an opening at the bottom of housing cover 102. Rim 112 generally includes ledge 128 and lips 130. Ledge 128 projects outwardly from sidewalls 110, for example, in a plane parallel to planar surface 108 (e.g., generally horizontal relative to the main extent of sidewalls 110).

In illustrated embodiments, lips 130 are (e.g., only) present along portions of rim 112 integrated with first sidewalls 110a (e.g., as more clearly shown in FIG. 7). As illustrated in FIGS. 1-6, lips 130 extend generally away from housing pan 104 and towards the plane of planar surface 108. First sidewalls 110a, ledge 128, and lips 130 collectively define a with a channel that is shaped to selectively receive a rim 112 of a separate lighting housing 100 when in a storage configuration.

Housing cover 102 can be selectively coupled to housing pan 104. Housing pan 104 can include a base 132 and perimeter walls 134 orthogonal to base 132 for coupling with housing cover 102 (e.g., when in an assembled configuration). When in an assembled configuration, housing cover 102 and housing pan 104 can maintain an air-tight seal, for example, between ledge 128 and base 132 (e.g., when a lighting element is present in lighting element aperture 136).

Base 132 is a planar surface that is generally parallel to planar surface 108 when in an assembled configuration. Base 132 includes a lighting element aperture 136 sized and positioned to support a lighting element (e.g., as shown in FIG. 7). In embodiments lighting element aperture 136 is structured to maintain a seal (e.g., to prevent air movement) when a lighting element is present therein.

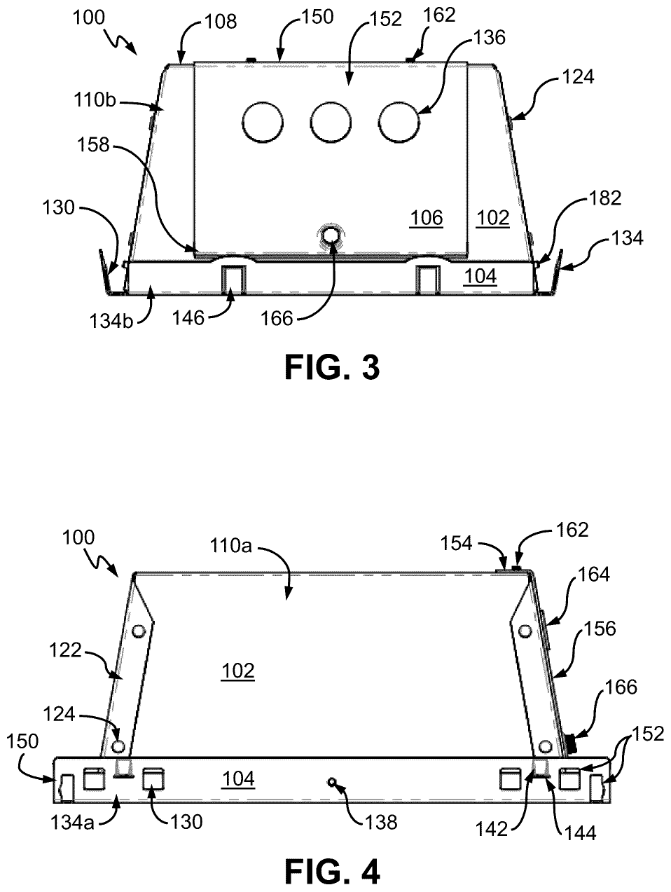

Perimeter walls 134 extend substantially the length and width of base 132 and include opposing first perimeter walls 134a and opposing second perimeter walls 134b. In some embodiments, the width of first perimeter walls 134a are greater than the width of second perimeter walls 134b. In some embodiments, the height of first perimeter walls 134a is greater than the height of second perimeter walls 134b (e.g., as illustrated in FIG. 3). First perimeter walls 134a and generally correspond to and can be sized commensurate with lips 130.

In some embodiments, perimeter walls 134 and lips 130 are tapered, outwardly expanding from base 132 and ledge 128 respectively. The taper of perimeter walls 134 and lips 130 can be similarly angled. For example, the angle defined between base 132 and perimeter walls 134 is equal to the angle defined between ledge 128 and lips 130. In some embodiments, the angle defined by ledge 128 and lips 130 is greater than the angle defined between base 132 and perimeter walls 134 such that when in an assembled configuration, perimeter walls 134 biases lips 130. This biasing can be applied in conjunction with locking tabs 142 and/or recesses 144 to secure housing cover 102 to housing pan 104 (e.g., when in an assembled configuration).

First perimeter walls 134a include holes 138 positioned and sized to align with corresponding holes 140 (e.g., illustrated in FIG. 7) of lips 130. Holes 138 and 140 are configured to receive screws or other fasteners to secure housing cover 102 to housing pan 104 (e.g., without exposing the cavity defined by housing cover 102).

First perimeter walls 134a include locking tabs 142. Locking tabs 142 are configured to fit into corresponding recesses 144 of lip 130 (e.g., as illustrated in FIG. 7). Locking tabs 142 and recesses 144 are positioned to align when lighting housing 100 is in the assembled configuration. When in the assembled configuration, locking tabs 142 are structured to retain housing cover 102 against housing pan 104. Locking tabs 142 extend over respective recesses 144 to resist (e.g., prevent) housing cover 102 from separating with housing pan 104. Housing cover 102 can be released (e.g., unlocked) from housing pan by applying force to locking tabs 142 in an outward direction (e.g., toward first perimeter walls 134a). By pushing locking tabs 142 so that the locking tabs reside substantially outside of recesses 144 and are not in contact with the first sidewall 110a, housing cover 102 can be uncoupled from housing pan 104. Put differently, depressing locking tabs 142 can cause first perimeter walls 134a to resiliently deform and disengage from lip 130. Accordingly, locking tabs 142 are configured to interfere with vertical movement between housing cover 102 and housing pan 104 when in an assembled configuration.

In some embodiments, lighting housing 100 can include one or more locking tabs 142 and corresponding recesses 144. In some embodiments, locking tabs and corresponding recesses 144 can be positioned anywhere along the first perimeter walls 134a and the first sidewalls 110a respectively. In some embodiments, recesses 144 are not present and locking tabs 142 are structured to extend over first sidewalls 110a when in an unbiased position.

In some embodiments, locking tabs 142 and tabs 144 are cooperating engaging structures configured to prevent movement of housing cover 102 relative to housing pan 104 (e.g., when in an assembled configuration.

Second perimeter walls 134b include tabs 146 and second sidewalls 110b include corresponding recesses 148 in ledge 128. In embodiments, tabs 146 and recesses 148 are structured to interfere (e.g., only) with horizontal movement between housing cover 102 and housing pan 104 when in an assembled configuration.

Lighting housing 100 can be structured to receive mounting hardware such as brackets, screws, or clamps to securely attach them to ceilings, walls, or other surfaces. In some implementations, lighting housing 100 is configured to be selectively coupled to adjustable mounting structures, such as lighting tracks, lighting stands, or other structures.

In some embodiments, first perimeter walls 134a can include mounting ends 142. Mounting ends 150 can be used to store, mount, or otherwise install lighting housing 100. For example, housing pans 104 can be selectively coupled to a lighting track or other structure via mounting ends 150. Mounting ends 150 can include apertures 152 to reduce the material required to construct lighting housing 100 without breaking the seal formed along housing cover 102 and housing pan 104. In some embodiments, apertures 152 can be structured to facilitate mounting of lighting housing 100, such as on a lighting track.

In some embodiments, planar surface 108 can include mounting holes 120. Mounting holes 120 can be sized and positioned to selectively couple light housing to a lighting stand, lighting track, or other structure.

In some embodiments, first sidewalls 110a can include holes configured to receive corresponding pegs from a wiring junction box contained within the cavity defined by housing cover 102.

With continued reference to FIGS. 1-6, wiring door 106 generally includes top edge 154, surface 156, and handle 158 according to an embodiment. Wiring door 106 is generally sized and positioned such that it spans wiring aperture 126 of housing cover 102 when in an assembled configuration.

Top edge 154 includes cutouts 160 configured to receive pegs 162 incorporated into planar surface 108 of housing cover 102. In some embodiments, pegs 162 can include an elongated portion configured to slide or otherwise be moveable within cutouts 160 and a broad top portion configured to rest on top edge 154 and to prevent vertical movement of top edge 154 when pegs 162 are within cutouts 160.

Surface 156 includes one or more wiring apertures 164. Wiring apertures 164 are sized and positioned to receive wiring associated with various lighting elements that can be contained within lighting housing 100 (e.g., when in an assembled configuration). In embodiments, wiring apertures 164 can be sized and structured based on a structure of an intended lighting element for use with lighting housing 100.

Surface 156 includes latch mechanism 166. Latch mechanism 166 can be structured and configured to selectively couple surface 156 to a sidewall 110. In illustrated embodiments, latch mechanism 166 can utilize a fastener such as a thumbscrew mated to a PEM nut insert, or can alternatively include a snap fit. Moreover, latch mechanism 166 can include other implementations of a fastener, such as, for example, a releasable adhesive, magnets, a clip, or the like. In some embodiments, latch mechanism 166 does not require a tool to unlatch or otherwise uncouple surface 156 from a sidewall 110.

Handle 158 is an adapted portion of surface 102 that is configured to be gripped or held by a user. Handle 158 can be gripped by a user to lift surface 156 off housing cover 102, for example, to access a wiring junction contained within housing cover 102. In embodiments, the edge between top edge 154 and surface 156 is structured and configured to bend or otherwise be flexible such that surface 156 can be lifted from a sidewall 110 (e.g., via handle 158) without uncoupling top surface from planar surface 108.

In the illustrated embodiments, wiring door 106 is selectively coupled to planar surface 108 such that it spans wiring aperture 126 on a sidewall 110b. In some embodiments, wiring aperture 126 and surface 156 of wiring door 106 can be positioned on a first sidewalls 110a or planar surface 108.

In some embodiments, wiring door 106 can be integrated or permanently incorporated into housing cover 102. For example, wiring door 106 can be integrated into housing cover 102, such that it is a single piece construction.

Wiring door 106 can provide a point of access to the cavity of housing cover 102 when in an assembled configuration. Wiring door 106 can be manipulated by a user, for example when latch mechanism 166 is unlatched, to lift wiring door 106 off housing cover 102. The user can then access the cavity of lighting housing 100 using wiring aperture 126, for example, during maintenance or adjustment of a lighting element installed in lighting housing 100.

In illustrated embodiments herein, housing cover 102 and housing pan 104 have rectilinear features. In some embodiments, housing cover 102, housing pan 104, and wiring door can be round or rounded in other embodiments. For example, the perimeter of housing pan 104 can be circular and housing cover 102 can include a single circular sidewall 110. For example, housing 102 can include a domed surface and/or sidewall(s) (e.g., rather than, or in addition to, planar surface 108). In such embodiments, the seal between rim 112 and perimeter wall(s) 134 can be maintained as described with respect to the illustrated embodiments. In such embodiments, the channel can be defined by rim 112 (e.g., between lip 130, ledge 128, and sidewalls 110) and perimeter wall(s) 134 as described with respect to the illustrated embodiment.

In embodiments, one or more of housing cover 102, housing pan 104, or wiring door 106 is configured to be a single-piece construction and formed of a single piece of material (e.g., rather than multiple components). Single-piece construction of housing cover 102, housing pan 104, and/or wiring door 106 can simplify the manufacturing process, improve structural integrity, and reduce weight among other benefits.

For example, embodiments of the present disclosure, such as lighting housing 100, simplify the manufacturing process by reducing the number of individual parts that need to be fabricated, assembled, and maintained. This can streamline production, lower production costs, and minimize the risk of assembly errors.

For example, embodiments of the present disclosure, such as lighting housing 100, can exhibit greater structural integrity and durability as there can be no joints where weaknesses or points of failure can occur. Further, the selective coupling using tabs (e.g., locking tabs 142 and tabs 144) and recesses (e.g., recesses 144, recesses 148) between housing cover 102 and housing pan 104 can offer improved resistance to vibration and stress, as well as improved mechanical properties such as stiffness and damping characteristics.

For example, embodiments of the present disclosure, such as lighting housing 100, can be structured and configured to optimize material usage, resulting in lighter-weight structures compared to assemblies made from multiple components. This can be advantageous for transportation and applications where weight is a critical factor, such as when mounting lighting housing(s) 100 on a lighting track.

For example, embodiments of the present disclosure, such as lighting housing 100, can result in significant long-term cost savings due to reduced material usage, simplified assembly processes, and lower maintenance requirements over the lifecycle of lighting housing 100.

Referring to FIG. 7, an exploded view of lighting housing 100 and a lighting element 200 is depicted, according to an embodiment.

Lighting housing 100 includes divider 168. Divider 168 is sized and structured to fit within the cavity defined by housing cover 102. In some embodiments, divider 168 is positioned within housing cover 102 such that an interior chamber is defined between a first sidewall 110a and divider 168 when in an assembled configuration. The interior chamber can be used to organize and store wiring extending through wiring aperture 126 of housing cover 102 and wiring apertures 164 of wiring door 106. Accordingly, divider 168 facilitates a wired connection to lighting element 200 contained within lighting housing 100 when in an assembled configuration.

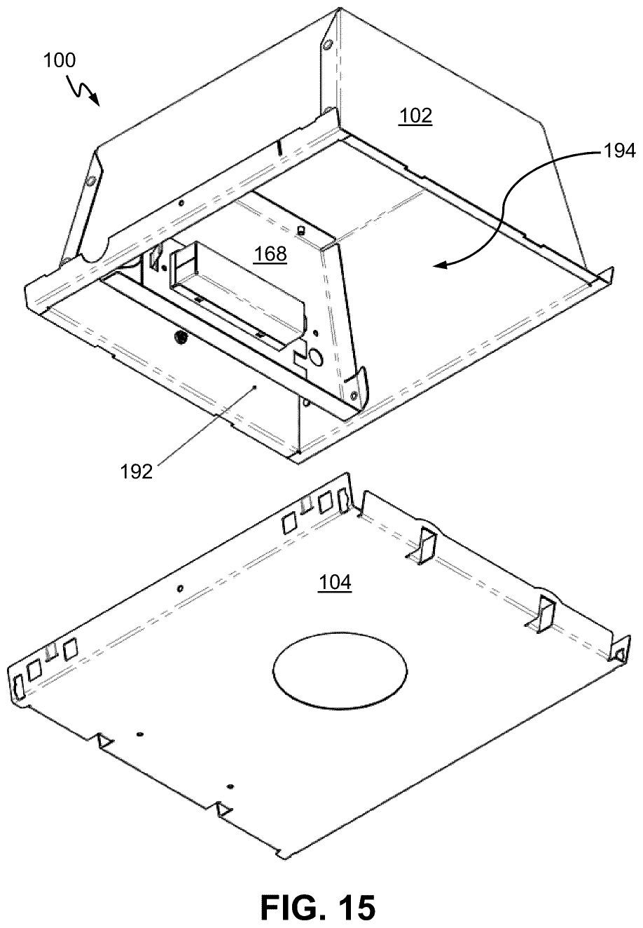

Divider 168 generally can include a wiring wall 170 and an internal wiring door 172. Wiring wall 170 includes a surface 174 and edges 176. The dimensions of surface 174 and edges 176 are selected based on the dimensions of planar surface 108 and first sidewalls 110a, as will be discussed with respect to FIG. 15. The wiring wall 170 may or may not be included, depending on the particular application for the lighting housing 100.

Edges 176 are structured and configured to selectively couple housing cover 102. Edges 176 can include side edges 176a configured to abut and extend along a portion of first sidewalls 110a, a top edge 176b configured to abut and extend along a portion of planar surface 108, and bottom edge 176c configured to abut and extend along a portion of base 132 of housing pan 104 (e.g., when in an assembled configuration). In some embodiments, edges 176 extend the length of the respective surfaces.

Side edges 176a include flexible tabs 178 and pegs 180 configured to extend through corresponding holes 118 of housing cover 102. Flexible tabs 178 can be biased against first sidewalls 110a and can include protrusions 182. Protrusions 182 can serve as a grip to release pegs 180 from holes 118. Top edge 178b includes holes 184 configured to receive corresponding pegs 186 extending from the interior side of planar surface 108.

Internal wiring door 172 is sized to span an aperture 188 defined by surface 174. Internal wiring door 172 includes a latching mechanism 190. Internal wiring door 172 is configured to seal aperture 188 when latching mechanism 190 is in a latched state and to provide access to lighting element 200 when opened (e.g., latching mechanism 190 is in an unlatched state). In some embodiments, internal wiring door 172 is configured to be removed from wiring wall 170 when in an unlatched state. In some embodiments, internal wiring door 172 is configured to pivot relative to surface 174 when in an unlatched state.

Lighting element 200 includes a coupling mechanism 202 structured and configured to selectively couple housing pan 104. In some embodiments, lighting element 200 can additionally or alternatively attach to housing cover 102. Lighting element 200 generally includes a portion 204 configured to span lighting element aperture 136 of housing pan 104. In some embodiments, lighting element 200 can maintain a seal (e.g., an air-tight seal) with base 132 of housing pan 104.

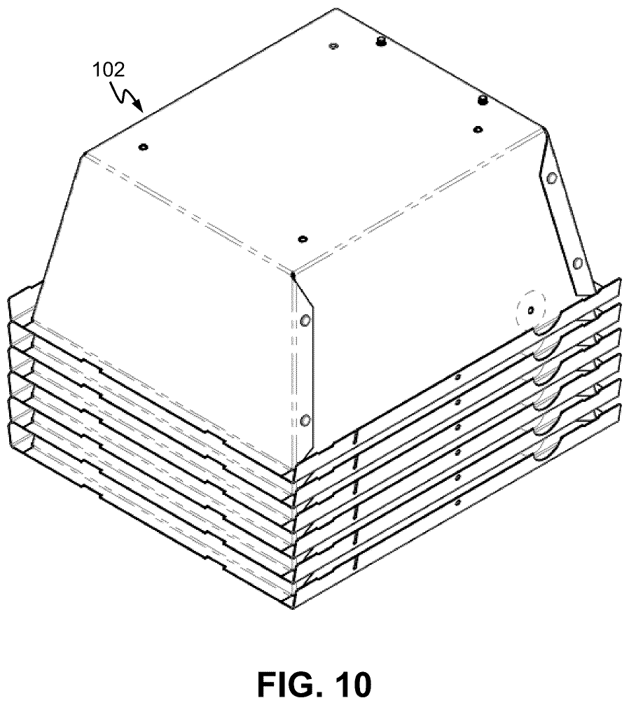

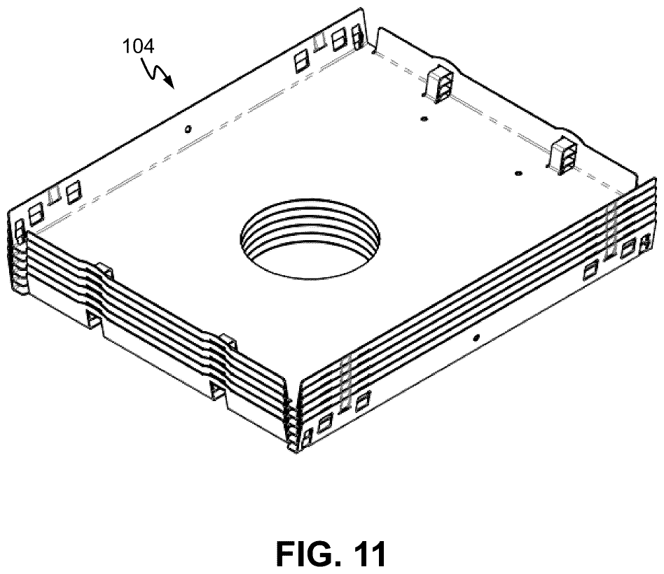

Referring to FIGS. 8-9, perspective views of lighting housing 100 in an assembled configuration are depicted, according to an embodiment.

When in a storage configuration (e.g., unassembled), components of lighting housing 100 (e.g., housing cover 102, housing pan 104) are configured to be compactly stored, for example, for transportation. For example, both hosing cover 102 and housing pan 104 can stack, for example, during shipping. FIG. 10 illustrates housing covers 102 in a storage configuration, according to an embodiment. FIG. 11 illustrates housing pans 104 in a storage configuration, according to an embodiment. As illustrated, housing covers 102 and housing pans 104 are structured to minimize internal space when stacked. Stacking lighting housing 100 components in a space-efficient manner can reduce shipping and storage costs, mitigate risk of damage (e.g., deformation), and allow for flexible logistics planning.

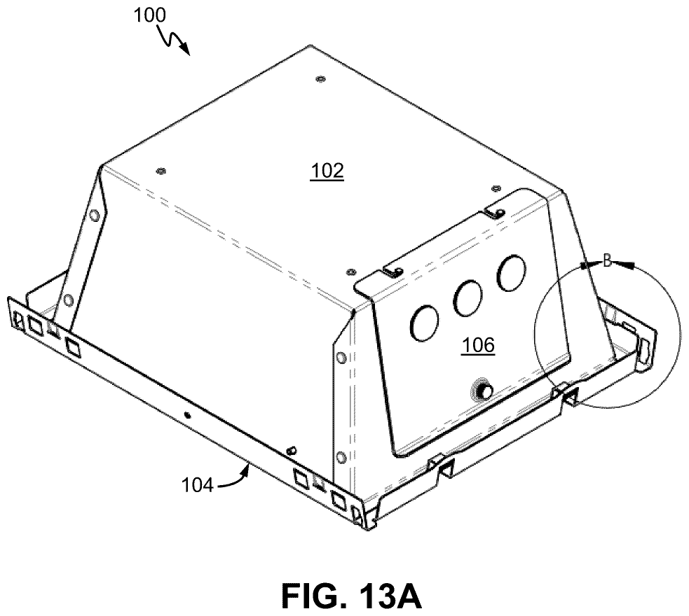

Referring to FIG. 12A, lighting housing 100 is depicted in a partially assembled state, according to an embodiment. FIG. 12B illustrates an expanded view of region A of FIG. 12A.

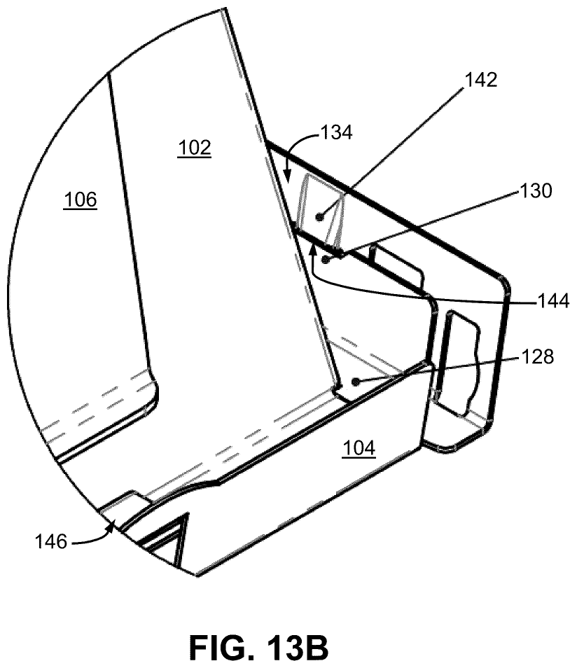

Referring to FIG. 13A, lighting housing 100 is depicted in an assembled configuration, according to an embodiment. FIG. 13B illustrates an expanded view of region B of FIG. 13A. As illustrated, locking tabs 142 and recess 144 are aligned such that locking tabs 142 extend over recesses 144 when in an assembled configuration. of out of engagement with its counterpart on or in the sidewall.

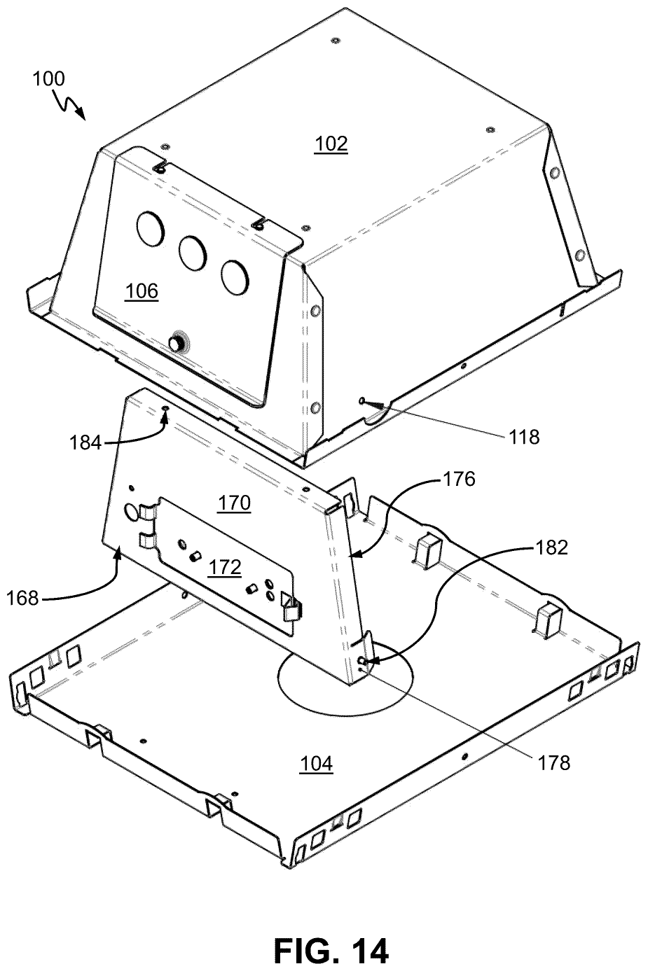

Referring to FIG. 14 illustrates a top-down perspective, partially exploded view of a light housing, according to an embodiment.

Referring to FIG. 15 illustrates a bottom-up perspective, partially exploded view of a light housing, according to an embodiment. As illustrated, dimensions of edges 176 of wiring wall 170 can be commensurate with corresponding surfaces of housing cover 102. For example, wiring wall 170 can be sized to separate the cavity of housing cover 102 into an interior wiring chamber 192 and an interior lighting element chamber 194. Interior wiring chamber 192 can serve as a wiring junction box when lighting housing 100 is in an assembled configuration.

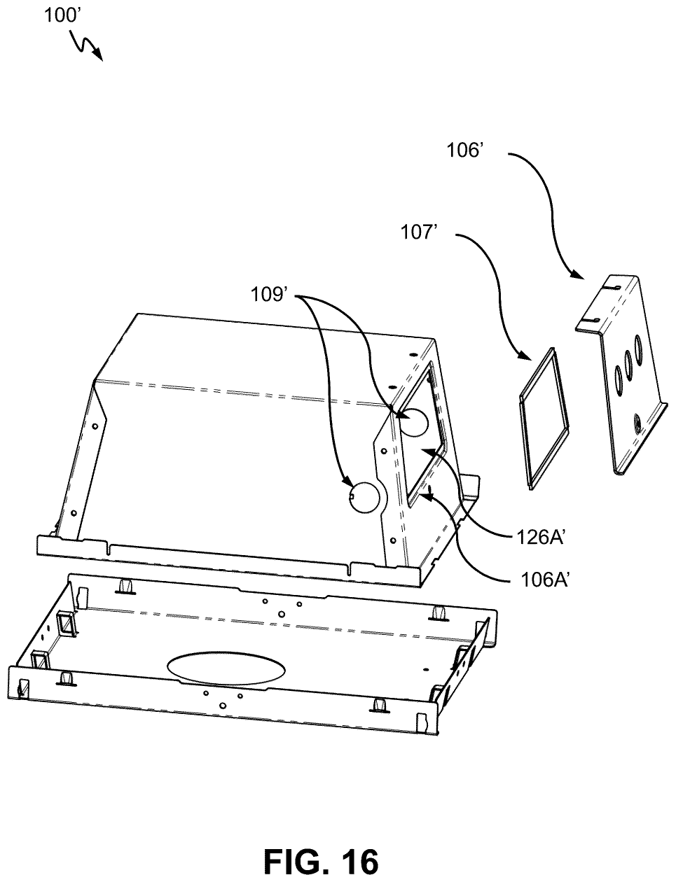

Referring to FIG. 16 illustrates a top-down perspective, partially exploded view of a variation of alighting housing 100′, according to an embodiment. Lighting housing 100′ is similar to embodiment 100, with certain notable differences. First, lighting housing 100′ does not include a wiring wall 170, but can include one if desired. In addition, the cover 106′ in embodiment 100′ is provided with an environmental seal, or gasket, 107′ that nests within a recessed peripheral flange 106A′ that surrounds wiring aperture 126′. Alternatively, the recessed flange can be omitted and the gasket 107′ can be adhered to the housing or the cover portion. Lighting housing 100′ also can include one or more “knockouts” 109′ comprising portions of the wall that are scored or perforated or otherwise attached, as desired, that can be removed. Lighting housing 100′ can have some or all of the attributes of lighting housing 100, if desired.

In embodiments, lighting housing 100, 100′ can be manipulated from a storage configuration (e.g., unassembled) to an assembled configuration without use of loose fasteners (e.g., rivets, screws, etc.) and/or a need for tools. For example, lighting housing 100 100′ can maintain an assembled configuration through (e.g., exclusively through) tensioning between components, such as snap fits. The simplicity of assembling lighting housing 100 100′ can reduce associated labor costs. Further, the lack of loose parts and fasteners can mitigate risk of lighting housing 100 100′ becoming unusable due to a lost or missing component.

It will be appreciated that other novel, useful, and non-obvious aspects and embodiments providing additional advantages are provided herein.

The present disclosure has described one or more illustrative embodiments. However, it should be appreciated that many equivalents, alternatives, variations, and modifications, aside from those expressly stated, are possible and within the scope of the invention.

1. A lighting housing, comprising:
a cover including a rim defining an aperture to an internal cavity, wherein a portion of the rim includes a raised edge; and
a pan, separable from the cover and including a perimeter wall configured to surround and continuously contact the rim such that the raised edge is parallel to the perimeter wall when the cover and the pan are engaged, wherein an inner face of the perimeter wall includes an integrally formed tab configured to engage the raised edge by extending inwardly relative to the cover, and wherein the tab is structured such that applying pressure to the tab causes the tab to resiliently deform and disengage from the raised edge.

2. The lighting housing of claim 1, further comprising:
a door pivotably coupled to the cover and spanning a second aperture, wherein the door is configured to provide access to the internal cavity.

3. The lighting housing of claim 2, wherein the door includes a snap mechanism configured to releasably latch the door to the cover.

4. The lighting housing of claim 1, further comprising:
a wiring wall configured to contact a portion of an inner face of the cover to divide the internal cavity into a wiring chamber and a lighting element chamber.

5. The lighting housing of claim 4, wherein the wiring chamber within the internal cavity is accessible via a wiring door attached to the cover.

6. The lighting housing of claim 1, wherein a seam between the cover and the pan prevents movement of air when the tab is engaged with the raised edge.

7. The lighting housing of claim 1, wherein a second portion of the rim includes a recess, and wherein the perimeter wall further includes a protruding member configured to occupy the recess when the tab is engaged with the raised edge, wherein the protruding member occupying the recess restricts movement of the cover relative to the pan.

8. The lighting housing of claim 1, wherein the aperture is configured to accommodate a lighting element therein.

9. The lighting housing of claim 1, wherein the inner face of the perimeter wall further includes an integrally formed second tab configured to engage the raised edge by extending inwardly relative to the cover, wherein the second tab is structured such that applying pressure to the second tab resiliently deforms the second tab to disengage from the raised edge, and wherein the second tab is positioned on an opposite end of the cover such that it extends toward the tab.

10. The lighting housing of claim 1, wherein the cover includes two or more sidewalls integrally formed with the rim, and wherein the internal cavity is further defined by an inner surface of the two or more sidewalls.

11. The lighting housing of claim 10, wherein the rim includes two or more portions each integrally formed with a respective sidewall of the two or more sidewalls, and wherein the portion of the rim including the raised edge is at least one of the two or more portions.

12. The lighting housing of claim 1, wherein a height of the perimeter wall is greater than a height of the raised edge.
